(19) United States
(12) Patent Application Publication
(10) Pub. No.: US 2013/0189456 A1
(43) Pub. Date: Jul. 25, 2013

(54) Magnetic Hood Ornament

(71) Applicant: Beth Ann Verbeyst-Hayes, Ewing, NJ (US)

(72) Inventor: Beth Ann Verbeyst-Hayes, Ewing, NJ (US)

(21) Appl. No.: 13/794,345

(22) Filed: Mar. 11, 2013

Related U.S. Application Data
(63) Continuation-in-part of application No. 29/435,392, filed on Oct. 23, 2012.
Application No. 29/435,392 is a continuation of application No. 29/415,420, filed on Mar. 9, 2012, now abandoned.
Application No. 29/415,420 is a continuation of application No. 29/348,735, filed on Apr. 26, 2010, now abandoned.

(51) Int. Cl. B60R 13/00

(52) U.S. Cl. CPC B60R 13/005
USPC 428/31

(57) ABSTRACT

A removable hood ornament is described in the disclosure which has a decorative head having an upper portion configured to have a novelty shape and/or novelty outer design and a lower connector area on an outer surface of the decorative head having a head connector thereon; and a base having an upper portion having a base connector configured to mate with the head connector, the base having on a lower portion thereof a first magnet device capable of magnetic attraction to a hood surface comprising metal when the removable hood ornament is installed on a hood surface. The decorative head and base may also be unitary or affixed to one another, and the various removable hood ornaments may be part of an assembly including secondary magnets which are magnetically engaged by the first magnet when placed on opposite sides of a hood surface.

### CROSS-REFERENCE TO RELATED APPLICATIONS

This application is a continuation-in-part of U.S. Design Patent Application No. 29/435,392, filed Oct. 23, 2012, which is a continuation of U.S. Design Patent Application No. 29/415,420, filed Mar. 9, 2012, which is a continuation of co-pending U.S. Design Patent Application No. 29/348,735, filed Apr. 26, 2010, the disclosure of each of such applications is incorporated herein by reference in its entirety.

### BACKGROUND OF THE INVENTION

The invention relates to a novel removable and interchangeable hood ornament for use on a metallic surface, such as a hood of an automobile.

### DESCRIPTION OF RELATED ART

Hood ornaments are known in the art and are typically specialty items in the symbol of an automobile manufacturer, for example, the Mercedes Benz® emblem, the leaping jaguar for a Jaguar® automobile, the Cadillac® symbol and the like. Such hood ornaments are typically valuable and to prevent theft or ease of removal are typically bolted through the hood of an automobile. Novelty hood ornaments using a similar design are known, but are niche products by virtue of the difficulty to install such hood ornaments, including drilling a hole in the hood if not already there, and/or using tools and other devices to remove and install the hood ornaments. Once installed, generally hood ornaments are not easily removed for the same reasons.

A popular trend that has developed over time is the desire to personalize one's automobile beginning with bumper stickers when cars were gaining in popular culture and popularity in the 1950's and 1960's. Drivers have also employed window decals, including the more recent “family” decal series showing adult, child and pet stick figures in various configurations to highlight the family on the rear window. The car antenna has also been a popular place of decoration and personalization, including antenna balls starting with the red rubber ball popularized by a gas company at the time, and leading to easy-to-install, more light weight foam balls that slip over the end of the antenna. Users can get a large number of such antenna balls for various likes and hobbies to personalize their car, whether a Disney® cartoon character, sporting equipment such as a soccer ball, a popular team symbol or color, a person's face or the like.

Other areas of car personalization include detailing of the outer surface of the car, placing personal items in the windows or hanging from the rear view mirror, placing items viewable on the rear dashboard of the car, specialty wheels and the like.

The hood ornament, however, has remained an area associated with the car manufacturer and as essentially a luxury trademark symbol, with the exception of limited novelty use.

U.S. Patent Publication No. 2010/0310794 A1 discloses a removable or decorative ornament having an enclosed magnet within a protective mesh cover for securing the decorative ornament to a metal surface of the car including the roof or hood. The ornament is described as a foam device and the magnet is a niobium magnet with sufficient force to hold it to the vehicle.

U.S. Patent Publication No. 2008/0028650 A1 teaches a method for putting a personalized device, such as a photo frame mounted on a hood by a bottom portion thereof that engages a mounted base on the car hood, which bottom portion and base interlock by rotation. The ornament may be a sports symbol or other items as well.

While there is continued product development in this area, there is a need in the art for drivers to continue to express individuality and personalize their automobiles and other vehicles using a device which is low cost, durable, unique and easy to install and remove.

### BRIEF SUMMARY OF THE INVENTION

The invention includes a removable hood ornament, comprising a decorative head having an upper portion configured to have a novelty shape and/or novelty outer design and a lower connector area on an outer surface of the decorative head having a head connector thereon; and a base having an upper portion having a base connector configured to mate with the head connector, the base having on a lower portion thereof a first magnet device capable of magnetic attraction to a hood surface comprising metal when the removable hood ornament is installed on a hood surface. Preferably, such magnetic attraction is sufficient to hold the decorative head and the base on a hood surface comprising metal. The first magnet device may also be for engaging a second magnet device capable of magnetic attraction to the first magnet device. In such case, such magnetic attraction between the first magnet device and the second magnet device is sufficient to hold the decorative head and the base on a hood surface comprising metal when the first magnet device and the second magnet device are positioned on opposite sides of a hood surface comprising metal.

The decorative head may comprises metal, metal alloy, polymeric material, composite material, and combinations thereof. The decorative head may be a solid molded piece or may have an inner surface defining a hollow core and a thickness between the outer and the inner surfaces of the decorative head measured transversely from the outer to the inner surface of the decorative. If so, the thickness of the decorative head may be about 0.01 mm to about 3 mm, preferably about 0.05 mm to about 1.5 mm. The hood ornament may also further comprises a material within a hollow core.

The decorative head may have a width measured transversely across the decorative head of about 2.5 cm to about 7 cm, preferably about 4 cm to about 5.5 cm. The decorative head has a height as measured longitudinally across the decorative head of about 2.5 cm to about 7 cm, preferably about 4 cm to about 7 cm.

In one embodiment, at least one of the head connector and the base connector comprises a receptacle configured to receive a fastener. The head connector may comprise the receptacle and the receptacle have an internal surface defining an opening, wherein the internal surface is threaded and the base connector is a screw having mating threads on an exterior surface thereof.

The invention also includes a removable hood ornament, comprising a decorative head having an upper portion configured to have a novelty shape and/or novelty outer design and a lower area on an outer surface of the decorative head affixed to or unitarily formed with a base portion, wherein the base portion has a lower portion thereof comprising a first magnet device for engaging a hood surface comprising metal when the removable hood ornament is installed on a hood surface comprising metal. The decorative head and the base portion in one embodiment are unitarily formed.

The invention further includes a removable hood ornament assembly comprising, (a) a decorative head having an upper portion configured to have a novelty shape and/or novelty outer design and a lower area on an outer surface of the decorative head affixed to or unitarily formed with a base portion, wherein the base portion has a first magnet device on a lower portion thereof for engaging a second magnet device capable of magnetic attraction to the first magnet device when the removable hood ornament is installed on a hood surface comprising metal; and (b) a second magnet device capable of magnetic attraction to the first magnet device when installed on a hood surface comprising metal. Such magnetic attraction is preferably sufficient to hold the decorative head and the base on a hood surface comprising metal.

The invention also further includes a removable hood ornament assembly, comprising: (a) a decorative head having an upper portion configured to have a novelty shape and/or novelty outer design and a lower connector area on an outer surface of the decorative head having a head connector thereon; and a base having an upper portion having a base connector configured to mate with the head connector, the base having a first magnet device in a lower portion thereof; and (b) a second magnet device capable of magnetic attraction to the first magnet device when installed on a hood surface comprising metal. Preferably such magnetic attraction is sufficient to hold the decorative head and the base on a hood surface comprising metal.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a front elevational view of a removable hood ornament according to an embodiment herein;

FIG. 2 is a longitudinal cross-sectional view taken along line 2-2 of the removable hood ornament of FIG. 1;

FIG. 3 is a partial longitudinal cross-sectional view of a removable hood ornament according to FIG. 1 in an installed removable hood ornament assembly;

FIG. 4 is a transverse cross-sectional view of the removable hood ornament of FIG. 1 taken along line 4-4;

FIG. 5 is a transverse cross-sectional view of the removable hood ornament of FIG. 1 taken along line 5-5;

FIG. 6 is a front elevational view of a further decorative embodiment of a removable hood ornament;

FIG. 7 is a front elevational view of a further decorative embodiment of a removable hood ornament;

FIG. 8 is a front elevational view of a further decorative embodiment of a removable hood ornament and assembly having a hollow core having a material therein;

FIG. 9 is a longitudinal cross-sectional view of the assembly of FIG. 8 taken along line 9-9;

FIG. 10 is a front elevational view of a further decorative embodiment of a removable hood ornament that is unitarily formed and has a hollow interior; and

FIG. 11 is a longitudinal cross-sectional view of FIG. 10 taken along line 11-11.

### DETAILED DESCRIPTION OF THE INVENTION

The invention includes removable hood ornaments and assemblies that enable drivers to express individuality and personalize their automobiles and/or other vehicles. The removable hood ornaments can be formed so as to maintain a low cost, present a unique message and look, to be very durable and very easy to install and remove.

The hood ornaments include a decorative head and base. The decorative heads may be configured to have any of a variety of novelty shapes and designs. The outer surface of the decorative head can be smooth and have a decorative design which is simply a color(s), pattern, picture, shape(s), words, and the like or it may be also shaped and have a design as well as a topographical surface so as to conform to a shape of an intended novel design or object. For example, the outer surface may be configured to take the shape of a sports object (baseball, football, soccer ball, skateboard, hockey puck and the like), a football helmet of a favorite NFL team, a Disney® character, a cartoon character, a pet breed, a decorative figurine for seasonal purposes (Christmas tree, shamrock, heart, sun, jack o'lantern, ghost and the like), even a celebrity likeness or photo on the outer surface of the decorative head.

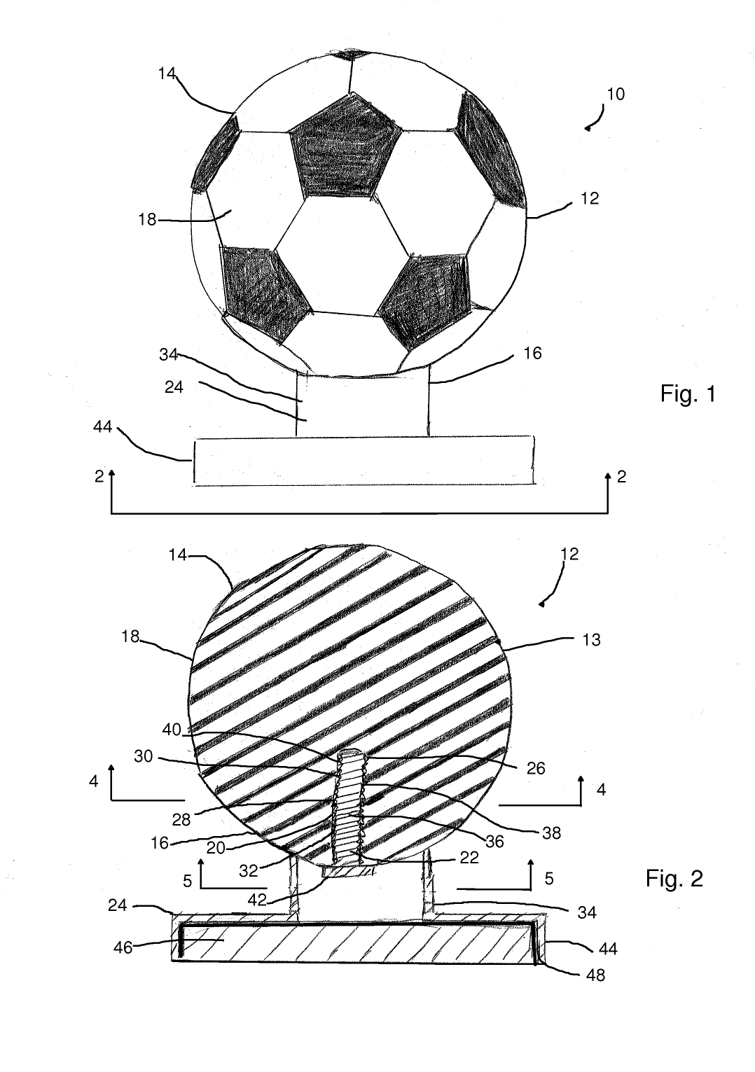

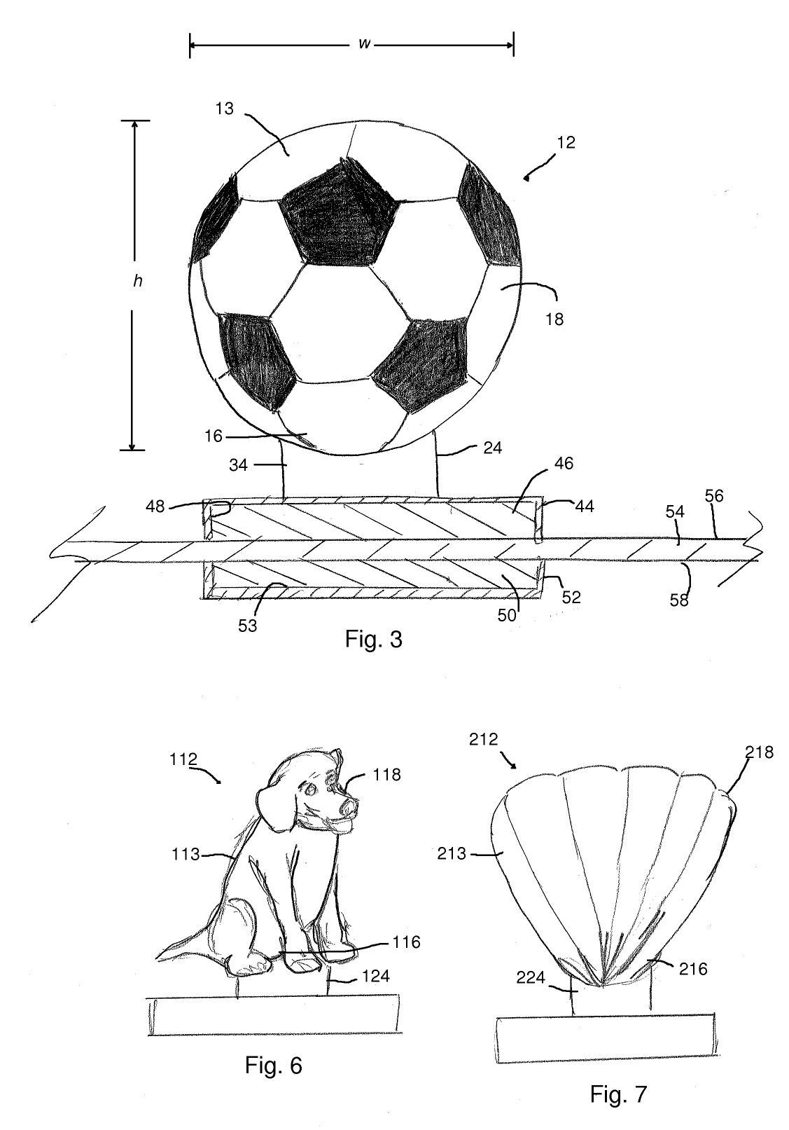

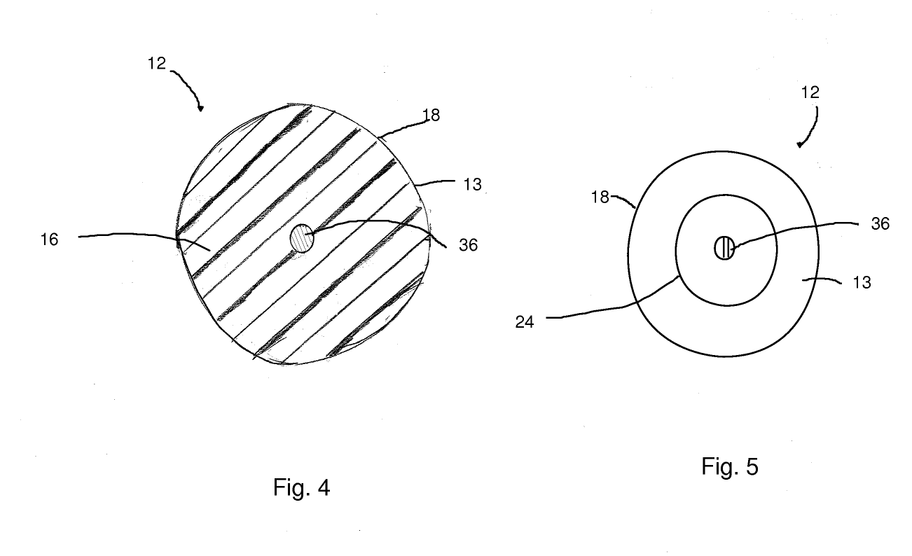

As shown in FIGS. 1-2 and 4-5, a first embodiment of a removable hood ornament is shown, and in FIG. 3 is shown a removable hood ornament assembly, generally referred to herein as assembly 10, including the removable hood ornament of FIGS. 1-2 and 4-5. Within the assembly 10, the removable hood ornament 12 of FIG. 1 has a decorative head 13 having an upper portion 14 configured to have a novelty shape and/or novelty outer design (which may be flush with the exterior surface of the head or topographical). As shown, the novelty shape and design is a soccer ball. The soccer ball has a smooth outer surface as shown with a soccer ball design thereon, but could be made also to have topography (such as showing some indentation at the seems and a more pillowed-out look between the seams). The decorative head 13 has a lower connector area 16 on the outer surface 18 of the decorative head. The connector area preferably has a head connector 20 in some form thereon. The head connector is preferably configured to work with a connector 22 on a base 24 of the removable hood ornament 12.

The decorative head connector and the base connector may be any suitable connectors that are configured to fit and/or mate together whether permanently or removably, for example, a screw and receptacle, a screw and nut, a quick connection, a snap-fit connection, a latch, a hook and eye and the like, and the nature of the connectors is not intended to be limiting. It is preferable that the connectors chosen be secure and able to withstand pressure from high wind and element exposure as well as weather-resistance considering the intended use is generally an outside use and if used on a moving vehicle can be traveling at a high rate of speed.

As shown in FIGS. 1-2, the head connector 20 is a receptacle 26 having an interior surface 28 which in this case has threads 30. The interior surface defines an opening 32 in the receptacle for receiving a base connector 22. The base 24 has an upper portion 34 that has a base connector 22 that is preferably configured to mate with the head connector 20. As shown, the base connector 22 is a screw 36. The screw 36 preferably has a screw head 42 and a body stemming therefrom with an exterior surface 40 having mating threads 38. The screw threads 38 are configured to lock in a mating manner with the threads 30 on the interior surface 28 of the receptacle 26. The connector portion of the base may vary in size for aesthetic reasons, but should be wide enough to contain the connectors and to easily operate the connector within the connector portion of the base. The connector portion may be appropriately sized also depending on the configuration and size of the decorative head. It is preferred that at least one of the head connector 20 and the base connector 24 includes a receptacle configured to receive a fastener. Thus, the receptacle and fastener such as the receptacle 26 and screw 36 may be in reversed positions from that shown.

On the lower portion 44 of the base 24 is a first magnet device 46. The magnet device may be one or more magnetic pieces set into the base either by a seated area for holding the magnet formed by the interior surface of the lower portion of the base, by a fastener, by a press-fit or by affixing using an adhesive or the like. As shown in FIG. 2, the magnet device 46 is a generally rectangularly-shaped magnet which is sized for a tight fit by forming the lower portion 44 of the base 24 so that the interior surface 48 of the lower portion 44 of the base conforms tightly to the magnet and is affixed by adhesive to the interior surface 48 of the lower portion 44 of the base 24. The magnet need not be rectangular in shape, and can be round or have other shapes, provided that it has sufficient strength to mount the removable hood ornament and preferably so that if a snug fit and adhesive are used to attach the magnet to the base of the hood ornament, it conforms to the shape of the lower portion of the base. It is also possible for extra security that a fastener (such as a mounting bolt) may be used to secure the magnet to the base of the hood ornament. The lower portion of the base may be configured and sized to accommodate the magnet selected, but also may be larger, depending on whether aesthetics of design or additional decorative head support is indicated and/or on whether the magnet is attached by snug fit and adhesive or by a fastener or other methods.

The magnet device 46 should be able to be installed so as to directly mount on the hood of a vehicle surface, wherein the surface is formed at least partially, or completely, by a metal, metal alloy, coated or painted metal or metal alloy, or another other similar surface having metal. Thus, the strength of the magnet should be sufficient to secure the removable hood ornament to a surface including metal, such as a hood surface comprising metal without coming off in wind conditions associated with driving, but not so strong that a user cannot remove it with application of a pulling hand force. While beneficial, it is preferred that the magnet device be strong enough to withstand severe weather conditions, however, this is not necessary as the device itself is removable in the event of severe weather.

Commercially available bar magnets are available that are made for attaching items to metallic surfaces of cars which are placed in travel conditions, for example, magnets used in hidden key holders and the like, magnets for attaching foam objects to car surfaces as in U.S. Patent Publication No. 2010/0310794 A1, incorporated herein by reference with respect to the magnet information, and heavy duty magnets for attaching hidden safes and other objects to metallic surfaces of vehicles. Thus, one of ordinary skill in the art could use any of the various bar magnets, niobium magnets and heavy duty magnets already employed for attaching items to vehicles for use in the present removable ornamental hood ornament embodiment. It is preferred that the magnetic attraction of the first magnet device is sufficient to hold the decorative head and the base on a hood surface comprising metal during daily use.

In one embodiment, the magnet device 46 may also be installed as part of a decorative hood ornament assembly wherein the assembly has a removable hood ornament such as that described above an shown in FIGS. 1-2 and 4-5 and a further has a second magnet for additional mounting security. Such an assembly is shown in FIG. 3. The first magnet device is as shown in FIGS. 1-2 and 4-5 and is installed in the assembly on an automobile hood 54 comprising metal on an upper surface 56 thereof. The second magnet 50 and assembly design of FIG. 3 is also useful if the user is installing a removable hood ornament as described herein on an automobile hood or other vehicle surface that is not primarily metallic, but is instead a molded polymeric or polymeric composite material or only partially metallic. The magnet device 46 in such an embodiment would still have sufficient strength to avoid detaching in strong winds and while driving, but also preferably has a polarity opposite from the second magnet 50 and further is capable of engaging the second magnet 50 for installation, for example on a hood of a vehicle. The first magnet device should engage the second magnet device which should be capable of magnetic attraction to the first magnet device and/or the first magnet device should engage a hood including metal, if the hood is formed so as to include metal.

Preferably the first or upper magnet's polarity is such that it is also attracted to and strongly mounts against the vehicle surface if it includes metal. While a second magnet device 50 can be employed on its own, to avoid corrosion and other interference from within the car engine area, it is preferred that the second magnet be positioned within a shell or housing such as housing 52. Housing 52 and second magnet device 50 can meet the lower surface 58 of the automobile hood 54. Thus, as installed, in the assembly of FIG. 3, the first magnet device 46 is configured so that it will engaging a second magnet device 50 magnetically which is capable of magnetic attraction to the first magnet device when the removable hood ornament 12 is installed on an upper surface 56 of a hood 54 comprising metal and the second magnet device 50 is contacted with the lower surface 58 of the hood 54. The magnetic attraction between the first magnet device 46 and the second magnet device 50 is sufficient to hold the decorative head and the base on a hood surface, preferably when the hood includes metal when the first magnet device and the second magnet device are positioned on opposite sides of the hood as noted above. The second magnet device 50 may be seated within the housing 52 using any of the techniques noted above with respect to the first magnet device, and is preferably fitted to conform to the interior surface 53 of the housing 52 and adhered thereto by an adhesive as well as a tight fit within the housing.

The decorative head 13 may be formed from a variety of materials including metals, metal alloys, polymeric materials, composite materials, and combinations thereof. Suitable metals include stainless steel, chrome, aluminum, iron, nickel, tin, copper, brass and the like, coated or not coated with a painted surface or paint coat molded thereon. Suitable polymeric materials include, but are not limited to, polymers and copolymers, as well as blends or alloys of the following polymers, polyamide, polyolefins such as polyethylene and polypropylene, polystyrene, polybutadiene-styrene, acrylonitrile-butadiene-styrene, polyimides, polyethers, polyoxyalkylenes and the like. Such polymers may be filled or unfilled for varying molding effects. Composites of such polymers are also useful, including those including fibers, short and long fibers, chopped fibers and the like, such as glass and carbon fibers. In addition, typical additives used in molding figurines, and other polymeric materials for suggested use outside, such as UV-absorbers, reflectants, corrosion resisters, thixotropic and rheological additives, plasticizers, ceramic additives, powdered polymeric additives, emulsifiers, and the like.

Molded polymeric materials used to make outdoor figurines, for use on the exterior of automobiles, and for use in molding other novelty items for durability may be used. For example, filled polyethylenes and polyamides are commonly used in such applications and are suitable herein. Such materials may also be painted, colored, or molded to have patterns, shapes and other indicia for creating a design on the exterior surface of the decorative head. The material may also be molded to have specific exterior shapes providing unique designs and topographical features.

The decorative heads used in the removable hood ornaments herein can have varying sizes, but should not be overly large both for securement reasons and to avoid blocking the view or distracting the view of a driver if installed on a vehicle hood. In preferred embodiments herein, and as shown with respect to FIG. 3, the decorative head 13, for example, may have a width w as measured transversely across the decorative head in its largest transverse area of about 2.5 cm to about 7 cm, and preferably about 4 cm to about 5.5 cm. Similarly, the decorative head 13 may have a height h as measured longitudinally across the decorative head of about 2.5 cm to about 7 cm and preferably about 4 cm to about 7 cm. The upper portion of the base is typically somewhat smaller in width than the decorative head, but may be the same or larger if desired. The height thereof should be minimized while accommodating any connectors to allow for the majority of the hood ornament height to be devoted to the decorative head. The lower portion of the base may be varied also for aesthetics and to accommodate the shape and size of the magnet as noted above.

Examples of molded decorative heads having a variety of styles beyond that shown in FIGS. 1-5 are found in FIGS. 6 and 7. In the embodiment of FIG. 6, a removable hood ornament 112 is shown having a molded decorative head 113 shaped to have an outer surface 118 shaped as a pet breed in the form of a dog. In this embodiment, all other features of the removable hood ornament are the same and like parts in embodiment 112 have like reference numbers to embodiment 12. The dog sits on a lower connector portion 116 and has a base 124. Such an embodiment can be used by pet lovers to personalize their car, and may, for example, also be used with other items used to personalize the vehicle, such as bumper stickers, flat message magnets, tail light covers and the like. In FIG. 7, a removable hood ornament embodiment 212 is shown also having like numbers having like parts to embodiment 12. The decorative head 213 is molded as a sea shell. The outer surface 218 can be molded smoothly or roughly for texture to the shell. The lower portion of the shell includes the connector portion 216 of the decorative head 213 and sits on base 224. A shell design may indicate a seasonal design, a beach lover or simply someone who collects shells. One skilled in the art would understand from this disclosure that a wide variety of themes, designs and other creations can be made, collected and be easily interchangeable by the user.

The decorative head may be a solid molded piece as shown in FIGS. 1-5, but need not be. The decorative head may be formed as an outer shell having an inner surface defining a hollow core. Such a hollow molded decorative head can remain hollow with a thin shell or can be a largely solid outer portion with a smaller hollow interior to save in manufacturing a wholly solid piece while maintaining good structural integrity. In addition, even a hollow shell with a smaller thickness can be filled with another less expensive or more lightweight material. For example, an outer hard composite shell can be filled with a polymer foam material.

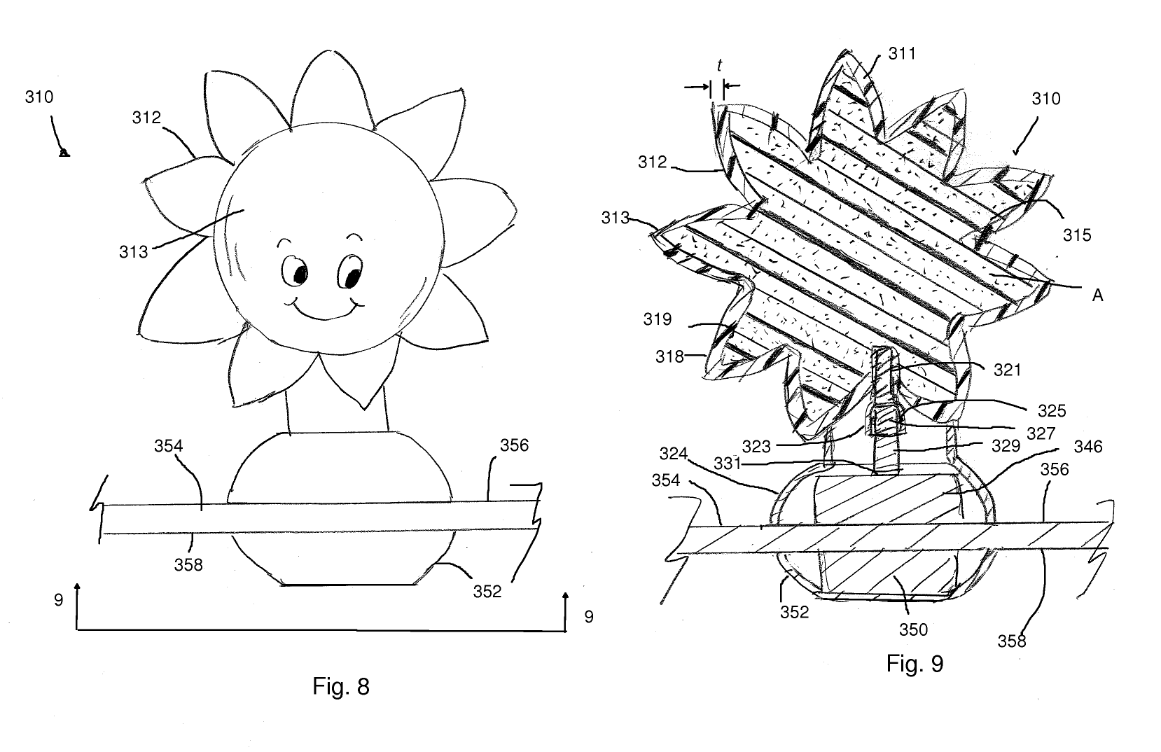

An example of a removable hood ornament having a shell with a smaller thickness may be seen with reference to FIGS. 8 and 9. In FIG. 8, an embodiment of a removable hood ornament 312 is shown. As with other embodiments noted above, like numbers indicate analogous parts to those of embodiment 12. The embodiment 312 may be formed to be used as a removable hood ornament directly installed alone on the upper surface 356 of a hood 354 such as a vehicle hood including metal, or as shown, may be used as part of an assembly 310 having a second magnet 350 and second magnet housing 352, wherein the second magnet and the edge of the housing 352 engage the lower surface 358 of the vehicle hood 354.

In the embodiment of FIGS. 8 and 9, the decorative head 313 has a thickness t measured between an outer surface 318 and an inner surface 319 of the shell 311 of the decorative head 313, wherein thickness t is measured transversely from the outer surface 318 to the inner surface 319 of the decorative head 313. The thickness may be varied depending on the design and the material being used. In one embodiment, the shell 311 has a thickness t of about 0.01 mm to about 3 mm, and preferably about 0.05 mm to about 1.5 mm.

As shown also as an optional feature, in the embodiment of FIGS. 8 and 9, the hood ornament 312 may also include a material A within the hollow core. The material A may be a lightweight foam, or a similar polymeric molding material, or may be metal core with a polymeric outer shell. As shown, the core 315 has a foam material A within the shell 311. Such a shell design is easy to mold using bladder injection molding, compression molding, insert molding or vacuum molding, and after setting can be filled with an expandable foam. Alternative methods of molding are possible depending on the material and configuration chosen for the decorative head.

Also, in the embodiment shown, different connectors are used from those in the prior embodiments 12, 112 and 212, wherein the connectors shown are a snap-fit locking connector, having an upper solid connector 321 with a open female receiving head 323 having an interior surface 325 configured to interlock with the male end 327 of a lower base connector 329. The male end 327 and female opening in the head 323 interlock through mating surfaces, such as by tabs, rotation locking and the like. Such connectors may be formed of polymeric materials, composites, metals or metal alloys, depending on stability and manufacturing preference. The other end 331 of the base connector 329 can be screwed into (either partially or completely through) or permanently adhered to the first magnet device 346. Thus, the connectors 321, 329 can not only hold the decorative head 313 to the base 324, but also retain the first magnet device 346 within the lower portion 344 of the base 324 in a situation where a more generally rectangularly-shaped magnet device is situated in a curved lower base portion 344 of the base 324.

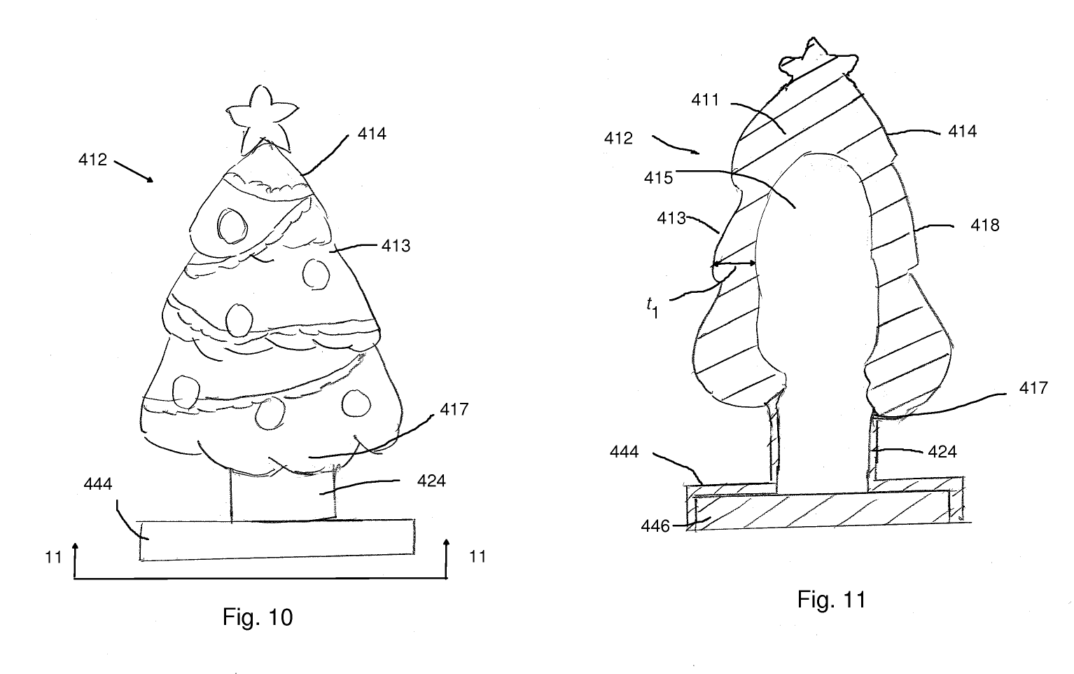

In a further embodiment herein shown in FIGS. 10 and 11, a holiday themed removable hood ornament 412 is shown having a decorative head 413 molded to have a shape of a Christmas tree, and having an upper portion 414 configured to have a novelty shape as shown and including a novelty outer design showing features of the Christmas tree. The lower portion 417 of the decorative head on its outer surface 418 is affixed to or unitarily formed with a base portion 424. As shown, the base is molded unitarily with the decorative head, but it should be understood that instead of a unitary molding, the decorative head and the base may be adhered using an adhesive, ultrasonic welding if both parts are formed of polymeric materials, a polymer heat weld, or a bonding agent for metal to polymer bonding, such as various acceptable heat- and pressure-sensitive adhesives. In the base portion 424, the lower portion 444 thereof houses the first magnet device 446 for engaging a hood surface such as an vehicle hood surface being at least partially metal when the removable hood ornament is installed on a hood surface. It should be understood to one skilled in the art based on this disclosure that this hood ornament embodiment may also include a lower housing with a second magnet that may be identical or similar to those shown in FIG. 3 or FIG. 9 although FIGS. 10 and 11 do not include this feature. In addition, FIGS. 10 and 11 illustrate also within the embodiment shown the optional feature of a hollow core 415 that is not filled and forming an outer shell 411 with a larger thickness t₁ leaving only a smaller hollow core 415. The thickness t₁ of the shell 411 may be the same or variable along the outer shell 411 and as shown varies along the design. This may be done for manufacturing convenience and economy to provide good structural integrity while minimizing use of material. In all other respects, the embodiments are the same. The various optional features may be interchanged to form additional embodiment permeations without departing from the spirit and scope of the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A removable hood ornament, comprising:
a decorative head having an upper portion configured to have a novelty shape and/or novelty outer design and a lower connector area on an outer surface of the decorative head having a head connector thereon; and
a base having an upper portion having a base connector configured to mate with the head connector, the base having on a lower portion thereof a first magnet device capable of magnetic attraction to a hood surface comprising metal when the removable hood ornament is installed on a hood surface.

2. The removable hood ornament according to claim 1, wherein such magnetic attraction is sufficient to hold the decorative head and the base on a hood surface comprising metal.

3. The removable hood ornament according to claim 1, wherein the first magnet device is for engaging a second magnet device capable of magnetic attraction to the first magnet device.

4. The removable hood ornament according to claim 3, wherein such magnetic attraction between the first magnet device and the second magnet device is sufficient to hold the decorative head and the base on a hood surface comprising metal when the first magnet device and the second magnet device are positioned on opposite sides of a hood surface comprising metal.

5. The removable hood ornament according to claim 1, wherein the decorative head comprises metal, metal alloy, polymeric material, composite material, and combinations thereof

6. The removable hood ornament according to claim 1, wherein the decorative head is a solid molded piece.

7. The removable hood ornament according to claim 1, wherein the decorative head has an inner surface defining a hollow core and a thickness between the outer and the inner surfaces of the decorative head measured transversely from the outer to the inner surface of the decorative.

8. The removable hood ornament according to claim 7, wherein the thickness of the decorative head is about 0.01 mm to about 3 mm.

9. The removable hood ornament according to claim 8, wherein the thickness of the decorative head is about 0.05 mm to about 1.5 mm.

10. The removable hood ornament according to claim 7, wherein the hood ornament further comprises a material within the hollow core.

11. The removable hood ornament according to claim 1, wherein the decorative head has a width measured transversely across the decorative head of about 2.5 cm to about 7 cm.

12. The removable hood ornament according to claim 11, wherein the decorative head has a width of about 4 cm to about 5.5 cm.

13. The removable hood ornament according to claim 1, wherein the decorative head has a height as measured longitudinally across the decorative head of about 2.5 cm to about 7 cm.

14. The removable hood ornament according to claim 13, wherein the decorative head has a height of about 4 cm to about 7 cm.

15. The removable hood ornament according to claim 1, wherein at least one of the head connector and the base connector comprises a receptacle configured to receive a fastener.

16. The removable hood ornament according to claim 15, wherein the head connector comprises the receptacle and the receptacle has an internal surface defining an opening, wherein the internal surface is threaded and the base connector is a screw having mating threads on an exterior surface thereof

17. A removable hood ornament, comprising a decorative head having an upper portion configured to have a novelty shape and/or novelty outer design and a lower area on an outer surface of the decorative head affixed to or unitarily formed with a base portion, wherein the base portion has a lower portion thereof comprising a first magnet device for engaging a hood surface comprising metal when the removable hood ornament is installed on a hood surface comprising metal.

18. The removable hood ornament according to claim 17, wherein the decorative head and the base portion are unitarily formed.

19. A removable hood ornament assembly comprising,
(a) a decorative head having an upper portion configured to have a novelty shape and/or novelty outer design and a lower area on an outer surface of the decorative head affixed to or unitarily formed with a base portion, wherein the base portion has a first magnet device on a lower portion thereof for engaging a second magnet device capable of magnetic attraction to the first magnet device when the removable hood ornament is installed on a hood surface comprising metal; and
(b) a second magnet device capable of magnetic attraction to the first magnet device when installed on a hood surface comprising metal.

20. The removable hood ornament assembly according to claim 19, wherein such magnetic attraction is sufficient to hold the decorative head and the base on a hood surface comprising metal.

21. A removable hood ornament assembly, comprising:
(a) a decorative head having an upper portion configured to have a novelty shape and/or novelty outer design and a lower connector area on an outer surface of the decorative head having a head connector thereon; and
a base having an upper portion having a base connector configured to mate with the head connector, the base having a first magnet device in a lower portion thereof; and
(b) a second magnet device capable of magnetic attraction to the first magnet device when installed on a hood surface comprising metal.

22. The removable hood ornament according to claim 21, wherein such magnetic attraction is sufficient to hold the decorative head and the base on a hood surface comprising metal.
